(19) United States
(12) Patent Application Publication
(10) Pub. No.: US 2014/0348240 A1
(43) Pub. Date: Nov. 27, 2014

(54) VIDEO CODING USING SAMPLE PREDICTION AMONG COLOR COMPONENTS

(71) Applicant: QUALCOMM Incorporated, San Diego, CA (US)

(72) Inventors: Woo-Shik Kim, San Diego, CA (US); Joel Sole Rojals, La Jolla, CA (US); Marta Karczewicz, San Diego, CA (US)

(73) Assignee: QUALCOMM Incorporated, San Diego, CA (US)

(21) Appl. No.: 14/283,855

(22) Filed: May 21, 2014

Related U.S. Application Data
(60) Provisional application No. 61/826,396, filed on May 22, 2013.

(51) Int. Cl. H04N 19/51; H04N 19/186; H04N 19/44

(52) U.S. Cl. CPC H04N 19/00684; H04N 19/00533; H04N 19/00315
USPC 375/240.16

(57) ABSTRACT

A video coder may reconstruct a residual signal of a predictor color component generated using motion prediction. The reconstructed residual signal of the predictor color component may include reconstructed residual sample values of the predictor color component. Additionally, the video coder may use the reconstructed residual sample values of the predictor color component to predict residual sample values of a different, predicted color component.

This application claims the benefit of U.S. Provisional Patent Application 61/826,396, filed May 22, 2013, the entire content of which is incorporated herein by reference.

### TECHNICAL FIELD

This disclosure relates to video coding (i.e., encoding and/or decoding of video data).

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicates the difference between the coded block and the predictive block. An intra-coded block is encoded according to an intra-coding mode and the residual data. For further compression, the residual data may be transformed from the pixel domain to a transform domain, resulting in residual coefficients, which then may be quantized. The quantized coefficients, initially arranged in a two-dimensional array, may be scanned in order to produce a one-dimensional vector of coefficients, and entropy coding may be applied to achieve even more compression.

### SUMMARY

In general, the techniques of this disclosure are related to the field of video coding and compression. In some examples, the techniques of this disclosure are related to the High-Efficiency Video Coding (HEVC) Range Extension, in which color spaces and sampling formats other than YCbCr 4:2:0 can be supported. As described herein, a video coder may reconstruct a residual signal of a predictor color component generated using motion prediction. The reconstructed residual signal of the predictor color component may include reconstructed residual sample values of the predictor color component. Additionally, the video coder may use the reconstructed residual sample values of the predictor color component to predict residual sample values of a different, predicted color component.

In one example, this disclosure describes a method of decoding video data, the method comprising: decoding a bitstream that includes an encoded representation of the video data, wherein decoding the bitstream comprises: reconstructing a residual signal of a first color component, wherein the residual signal of the first color component is generated using motion prediction, the reconstructed residual signal of the first color component including reconstructed residual sample values of the first color component; and using the reconstructed residual sample values of the first color component to predict residual sample values of a second, different color component.

In another example, this disclosure describes a method of encoding video data, the method comprising: generating a bitstream that comprises an encoded representation of the video data, wherein generating the bitstream comprises: generating, by use of motion prediction, a residual signal for a first color component; reconstructing the residual signal of the first color component, the reconstructed residual signal of the first color component including the reconstructed residual sample values of the first color component; and using reconstructed sample values of the first color component to predict sample values of the second color component.

In another example, this disclosure describes a video coding device comprising: a data storage medium configured to store video data; and one or more processors configured to generate or decode a bitstream comprising an encoded representation of the video data, wherein as part of generating or decoding the bitstream, the one or more processors: reconstruct a residual signal of a first color component, wherein the residual signal of the first color component is generated using motion prediction, the reconstructed residual signal of the first color component including reconstructed residual sample values of the first color component; and use the reconstructed residual sample values of the first color component to predict residual sample values of a second, different color component.

In another example, this disclosure describes a video coding device comprising: means for reconstructing a residual signal of a first color component, wherein the residual signal of the first color component is generated using motion prediction, the reconstructed residual signal of the first color component including reconstructed residual sample values of the first color component; and means for using the reconstructed residual sample values of the first color component to predict residual sample values of a second, different color component.

In another example, this disclosure describes a non-transitory computer-readable data storage medium having instructions stored thereon that when executed cause a video coding device to: reconstruct a residual signal of a first color component, wherein the residual signal of the first color component is generated using motion prediction, the reconstructed residual signal of the first color component including reconstructed residual sample values of the first color component; and use the reconstructed residual sample values of the first color component to predict residual sample values of a second, different color component.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video coding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 is a flowchart illustrating an example operation of a video encoder, in accordance with one or more techniques of this disclosure.

FIG. 5 is a flowchart illustrating an example operation of a video decoder, in accordance with one or more techniques of this disclosure.

FIG. 6 is a flowchart illustrating an example operation of a video encoder, in accordance with one or more techniques of this disclosure.

FIG. 7 is a flowchart illustrating an example operation of a video decoder, in accordance with one or more techniques of this disclosure.

### DETAILED DESCRIPTION

In many video coding standards, a block of pixels may actually comprise two or more blocks of samples for different color components. For example, a block of pixels may actually comprise a block of luma samples to indicate brightness and two blocks of chrominance (i.e., chroma) samples to indicate color. In some situations, the sample values for a color component may be correlated with the corresponding sample values of a different color component. In other words, the values of samples of one color component may have a mutual relationship with values of samples of another color component. The reduction of such correlation may result in a reduction in the amount of data required to represent the sample values.

In accordance with one or more techniques of this disclosure, the correlation between sample values of different color components may be reduced in inter predicted blocks. Thus, in accordance with one or more techniques of this disclosure, a video coder may generate or decode a bitstream that comprises an encoded representation of video data. As part of generating or decoding the bitstream, the video coder may reconstruct a residual signal of a first color component (i.e., a predictor color component). The residual signal of the first color component may be generated using motion prediction. The reconstructed residual signal of the first color component includes reconstructed residual sample values of the first color component. Furthermore, the video coder may use the reconstructed residual sample values of the first color component to predict residual sample values of a second, different color component. In this way, the correlation between sample values of the first and second color components may be reduced, potentially resulting in the bitstream being smaller.

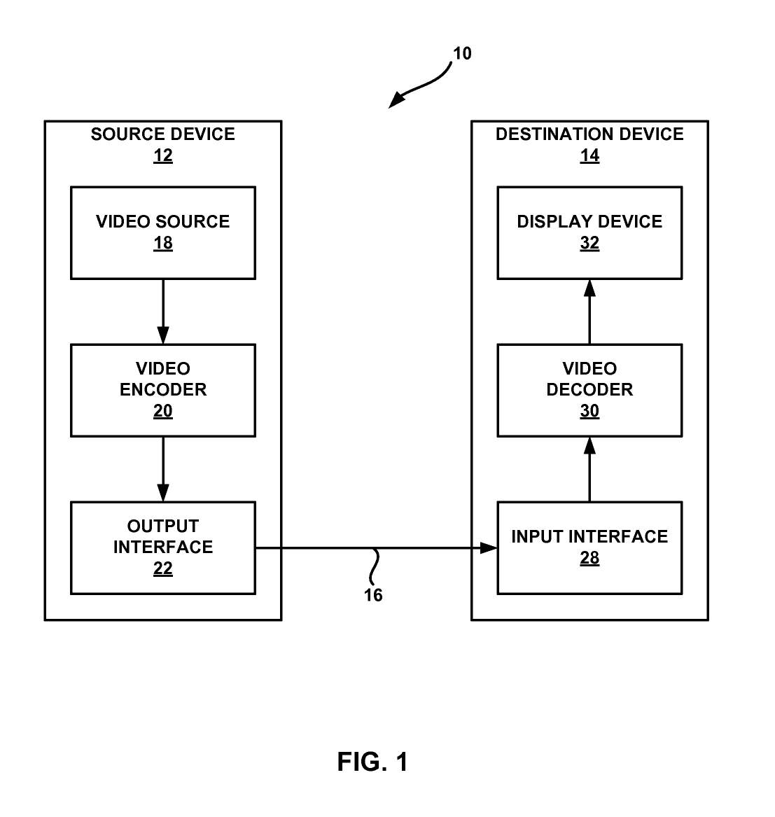

FIG. 1 is a block diagram illustrating an example video coding system 10 that may utilize the techniques of this disclosure. As used herein, the term “video coder” refers generically to both video encoders and video decoders. In this disclosure, the terms “video coding” or “coding” may refer generically to video encoding or video decoding.

As shown in FIG. 1, video coding system 10 includes a source device 12 and a destination device 14. Source device 12 generates encoded video data. Accordingly, source device 12 may be referred to as a video encoding device or a video encoding apparatus. Destination device 14 may decode the encoded video data generated by source device 12. Accordingly, destination device 14 may be referred to as a video decoding device or a video decoding apparatus. Source device 12 and destination device 14 may be examples of video coding devices or video coding apparatuses.

Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, or the like.

Destination device 14 may receive encoded video data from source device 12 via a channel 16. Channel 16 may comprise one or more media or devices capable of moving the encoded video data from source device 12 to destination device 14. In one example, channel 16 may comprise one or more communication media that enable source device 12 to transmit encoded video data directly to destination device 14 in real-time. In this example, source device 12 may modulate the encoded video data according to a communication standard, such as a wireless communication protocol, and may transmit the modulated video data to destination device 14. The one or more communication media may include wireless and/or wired communication media, such as a radio frequency (RF) spectrum or one or more physical transmission lines. The one or more communication media may form part of a packet-based network, such as a local area network, a wide-area network, or a global network (e.g., the Internet). The one or more communication media may include routers, switches, base stations, or other equipment that facilitate communication from source device 12 to destination device 14.

In another example, channel 16 may include a storage medium that stores encoded video data generated by source device 12. In this example, destination device 14 may access the storage medium, e.g., via disk access or card access. The storage medium may include a variety of locally-accessed data storage media such as Blu-ray discs, DVDs, CD-ROMs, flash memory, or other suitable digital storage media for storing encoded video data.

In a further example, channel 16 may include a file server or another intermediate storage device that stores encoded video data generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), hypertext transfer protocol (HTTP) streaming servers, file transfer protocol (FTP) servers, network attached storage (NAS) devices, and local disk drives.

Destination device 14 may access the encoded video data through a standard data connection, such as an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of a variety of multimedia applications, such as over-the-air television broadcasts, cable television transmissions, satellite television transmissions, streaming video transmissions, e.g., via the Internet, encoding of video data for storage on a data storage medium, decoding of video data stored on a data storage medium, or other applications. In some examples, video coding system 10 may be configured to support one-way or two-way video transmission to support applications such as video streaming, video playback, video broadcasting, and/or video telephony.

FIG. 1 is merely an example and the techniques of this disclosure may apply to video coding settings (e.g., video encoding or video decoding) that do not necessarily include any data communication between the encoding and decoding devices. In other examples, data (e.g., video data) is retrieved from a local memory, streamed over a network, or the like. A video encoding device may encode and store data (e.g., video data) to memory, and/or a video decoding device may retrieve and decode data (e.g., video data) from memory. In many examples, the encoding and decoding is performed by devices that do not communicate with one another, but simply encode data (e.g., video data) to memory and/or retrieve and decode data (e.g., video data) from memory.

In the example of FIG. 1, source device 12 includes a video source 18, a video encoder 20, and an output interface 22. In some examples, output interface 22 may include a modulator/demodulator (modem) and/or a transmitter. Video source 18 may include a video capture device, e.g., a video camera, a video archive containing previously-captured video data, a video feed interface to receive video data from a video content provider, and/or a computer graphics system for generating video data, or a combination of such sources of video data.

Video encoder 20 may encode video data from video source 18. In some examples, source device 12 directly transmits the encoded video data to destination device 14 via output interface 22. In other examples, the encoded video data may also be stored onto a storage medium or a file server for later access by destination device 14 for decoding and/or playback.

In the example of FIG. 1, destination device 14 includes an input interface 28, a video decoder 30, and a display device 32. In some examples, input interface 28 includes a receiver and/or a modem. Input interface 28 may receive encoded video data over channel 16. Display device 32 may be integrated with or may be external to destination device 14. In general, display device 32 displays decoded video data. Display device 32 may comprise a variety of display devices, such as a liquid crystal display (LCD), a plasma display, an organic light emitting diode (OLED) display, or another type of display device.

Video encoder 20 and video decoder 30 each may be implemented as any of a variety of suitable circuitry, such as one or more microprocessors, digital signal processors (DSPs), application-specific integrated circuits (ASICs), field-programmable gate arrays (FPGAs), discrete logic, hardware, or any combinations thereof. If the techniques are implemented partially in software, a device may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors. Each of video encoder 20 and video decoder 30 may be included in one or more encoders or decoders, either of which may be integrated as part of a combined encoder/decoder (CODEC) in a respective device.

This disclosure may generally refer to video encoder 20 “signaling” certain information to another device, such as video decoder 30. The term “signaling” may generally refer to the communication of syntax elements and/or other data used to decode the compressed video data. Such communication may occur in real- or near-real-time. Alternately, such communication may occur over a span of time, such as might occur when storing syntax elements to a computer-readable storage medium in an encoded bitstream at the time of encoding, which then may be retrieved by a decoding device at any time after being stored to this medium.

In some examples, video encoder 20 and video decoder 30 operate according to a video compression standard, such as ISO/IEC MPEG-4 Visual and ITU-T H.264 (also known as ISO/IEC MPEG-4 AVC), including its Scalable Video Coding (SVC) extension, Multiview Video Coding (MVC) extension, and MVC-based 3DV extension. In some instances, any legal bitstream conforming to MVC-based 3DV always contains a sub-bitstream that is compliant to a MVC profile, e.g., stereo high profile. Furthermore, there is an ongoing effort to generate a three-dimensional video (3DV) coding extension to H.264/AVC, namely AVC-based 3DV. In other examples, video encoder 20 and video decoder 30 may operate according to ITU-T H.261, ISO/IEC MPEG-1 Visual, ITU-T H.262 or ISO/IEC MPEG-2 Visual, ITU-T H.263, ISO/IEC MPEG-4 Visual, and ITU-T H.264, ISO/IEC Visual.

In the example of FIG. 1, video encoder 20 and video decoder 30 may operate according to the High Efficiency Video Coding (HEVC) standard developed by the Joint Collaboration Team on Video Coding (JCT-VC) of ITU-T Video Coding Experts Group (VCEG) and ISO/IEC Motion Picture Experts Group (MPEG). A draft of the HEVC standard, referred to as “HEVC Working Draft 6” is described in Bross et al., “High Efficiency Video Coding (HEVC) text specification draft 6,” Joint Collaborative Team on Video Coding (JCT-VC) of ITU-T SG16 WP3 and ISO/IEC JTC1/SC29/WG11, 7^{th} Meeting, Geneva, Switzerland, November 2011. At least as of May 9, 2014, HEVC Working Draft 6 is available from http://phenix.it-sudparis.eu/jct/doc_end_user/documents/8_San%20Jose/wg11/JCTVC-H1003-v1.zip. Another draft of the upcoming HEVC standard, referred to as “HEVC Working Draft 9” is described in Bross et al., “High Efficiency Video Coding (HEVC) text specification draft 9,” Joint Collaborative Team on Video Coding (JCT-VC) of ITU-T SG16 WP3 and ISO/IEC JTC1/SC29/WG11, 11^{th} Meeting, Shanghai, China, October 2012. At least as of May 9, 2014, HEVC Working Draft 9 is available from http://phenix.int-evey.fr/jct/doc_end_user/documents/11_Shanghai/wg11/JCTVC-K1003-v13.zip.

Furthermore, there are ongoing efforts to produce SVC, multi-view coding, and 3DV extensions for HEVC. The SVC extension of HEVC may be referred to as HEVC-SVC. The 3DV extension of HEVC may be referred to as HEVC-based 3DV or 3D-HEVC. 3D-HEVC is based, at least in part, on solutions proposed in Schwarz et al, “Description of 3D Video Coding Technology Proposal by Fraunhofer HHI (HEVC compatible configuration A),” ISO/IEC JTC1/SC29/WG11, Doc. MPEG11/M22570, Geneva, Switzerland, November/December 2011, hereinafter “m22570” and Schwarz et al, “Description of 3D Video Coding Technology Proposal by Fraunhofer HHI (HEVC compatible configuration B), ISO/IEC JTC1/SC29/WG11, Doc. MPEG11/M22571, Geneva, Switzerland, November/December 2011, hereinafter “m22571.” A reference software description for 3D-HEVC is available at Schwarz et al, “Test Model under Consideration for HEVC based 3D video coding,” ISO/IEC JTC1/SC29/WG11 MPEG2011/N12559, San Jose, USA, February 2012. Reference software, namely HTM version 3.0 is available, at least as of May 9, 2014, from https://hevc.hhi.fraunhofer.de/svn/svn_{—}3DVCSoftware/tags/HTM-3.0/.

Additionally, there are ongoing efforts to produce a Range Extension standard for HEVC. The Range Extension standard for HEVC includes extending video coding for color spaces other than YCbCr 4:2:0, such as YCbCr 4:2:2, YCbCr 4:4:4, and RGB. Flynn et al., “High Efficiency Video Coding (HEVC) Range Extensions text specification: Draft 2 (for PDAM),” Joint Collaborative Team on Video Coding (JCT-VC) of ITU-T SG 16 WP 3 and ISO/IEC JTC 1/SC 29/WG 11, 12th Meeting: Geneva, CH, 14-23 Jan. 2013, document no. JCTVC-L1005v4 (hereinafter, “JCTVC-L1005v4”), is a draft of the Range Extension standard for HEVC. At least as of May 9, 2014, JCTVC-L1005v4 was available from http://phenix.int-evey.fr/jct/doc_end_user/current_document.php?id=7276.

In HEVC and other video coding standards, a video sequence typically includes a series of pictures. Pictures may also be referred to as “frames.” A picture may include three sample arrays, denoted S_{L}, S_{Cb} and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may comprise a coding tree block of luma samples, two corresponding coding tree blocks of chroma samples, and syntax structures used to code the samples of the coding tree blocks. A coding tree block may be an N×N block of samples. A CTU may also be referred to as a “tree block” or a “largest coding unit” (LCU). The CTUs of HEVC may be broadly analogous to the macroblocks of other video coding standards, such as H.264/AVC. However, a CTU is not necessarily limited to a particular size and may include one or more coding units (CUs). A slice may include an integer number of CTUs ordered consecutively in a scanning order (e.g., a raster scan).

This disclosure may use the term “video unit,” “video block,” or “block” to refer to one or more blocks of samples and syntax structures used to code samples of the one or more blocks of samples. Example types of video units may include CTUs, CUs, PUs, transform units (TUs), macroblocks, macroblock partitions, and so on.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may comprise a coding block of luma samples and two corresponding coding blocks of chroma samples of a picture that has a luma sample array, a Cb sample array and a Cr sample array, and syntax structures used to code the samples of the coding blocks. Video encoder 20 may partition a coding block of a CU into one or more prediction blocks. A prediction block may be a rectangular (i.e., square or non-square) block of samples on which the same prediction is applied. A prediction unit (PU) of a CU may comprise a prediction block of luma samples, two corresponding prediction blocks of chroma samples of a picture, and syntax structures used to predict the prediction block samples. Video encoder 20 may generate predictive blocks (e.g., predictive luma, Cb and Cr blocks) for prediction blocks (e.g., luma, Cb and Cr prediction blocks) of each PU of the CU. In some examples, the samples of predictive blocks of a block (e.g., a PU, CU, etc.) may be referred to herein as a reference signal for the block.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture to which the PU belongs (i.e., the picture associated with the PU).

If video encoder 20 uses inter prediction to generate the predictive blocks of a PU, video encoder 20 may generate the predictive blocks of the PU based on decoded samples of one or more pictures other than the picture associated with the PU. Inter prediction may be uni-directional inter prediction (i.e., uni-prediction) or bi-directional inter prediction (i.e., bi-prediction). To perform uni-prediction or bi-prediction, video encoder 20 may generate a first reference picture list (RefPicList0) and a second reference picture list (RefPicList1) for a current slice. Each of the reference picture lists may include one or more reference pictures.

When using uni-prediction, video encoder 20 may search the reference pictures in either or both RefPicList0 and RefPicList1 to determine a reference location within a reference picture. Furthermore, when using uni-prediction, video encoder 20 may generate, based at least in part on samples corresponding to the reference location, the predictive sample blocks for the PU. Moreover, when using uni-prediction, video encoder 20 may generate a single motion vector that indicates a spatial displacement between a prediction block of the PU and the reference location. To indicate the spatial displacement between a prediction block of the PU and the reference location, a motion vector may include a horizontal component specifying a horizontal displacement between the prediction block of the PU and the reference location and may include a vertical component specifying a vertical displacement between the prediction block of the PU and the reference location.

When using bi-prediction to encode a PU, video encoder 20 may determine a first reference location in a reference picture in RefPicList0 and a second reference location in a reference picture in RefPicList1. Video encoder 20 may then generate, based at least in part on samples corresponding to the first and second reference locations, the predictive blocks for the PU. Moreover, when using bi-prediction to encode the PU, video encoder 20 may generate a first motion vector indicating a spatial displacement between a prediction block of the PU and the first reference location and a second motion vector indicating a spatial displacement between the prediction block of the PU and the second reference location.

After video encoder 20 generates predictive blocks (e.g., predictive luma (Y), chroma Cb and chroma Cr blocks) for one or more PUs of a CU, video encoder 20 may generate residual blocks (e.g., a luma residual block, Cb residual block, and a Cr residual block) for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block. This disclosure may refer to samples of the residual blocks of a block (e.g., CU) as residual signals for the block.

Furthermore, video encoder 20 may use quad-tree partitioning to decompose the residual blocks (e.g., luma, Cb and Cr residual blocks) of a CU into one or more transform blocks (e.g., luma, Cb and Cr transform blocks). A transform block may be a rectangular (e.g., square or non-square) block of samples on which the same transform is applied. A transform unit (TU) of a CU may comprise a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block.

Video encoder 20 may apply one or more transforms to a transform block of a TU to generate a coefficient block for the TU. A coefficient block may be a two-dimensional array of transform coefficients. A transform coefficient may be a scalar quantity. For example, video encoder 20 may apply one or more transforms to a luma transform block of a TU to generate a luma coefficient block for the TU. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU. In some examples, video encoder 20 may skip the transform and treat a transform block (e.g., a block of residual samples) in the same manner as a transform coefficient block.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. In some examples, video encoder 20 may skip quantization of the transform coefficient block. Furthermore, video encoder 20 may inverse quantize transform coefficients and may apply an inverse transform to the transform coefficients in order to reconstruct transform blocks of TUs of CUs of a picture. The video encoder 20 may use the reconstructed transform blocks of TUs of a CU and the predictive blocks of PUs of the CU to reconstruct coding blocks of the CU. By reconstructing the coding blocks of each CU of a picture, video encoder 20 may reconstruct the picture. Video encoder 20 may store reconstructed pictures in a decoded picture buffer (DPB). Video encoder 20 may use reconstructed pictures in the DPB for inter prediction and intra prediction.

After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients. Video encoder 20 may output the entropy-encoded syntax elements in a bitstream.

Video encoder 20 may output a bitstream that includes a sequence of bits that forms a representation of coded pictures and associated data. The bitstream may comprise a sequence of network abstraction layer (NAL) units. Each of the NAL units may include a NAL unit header and may encapsulate a raw byte sequence payload (RBSP). The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a picture parameter set (PPS), a second type of NAL unit may encapsulate an RBSP for a coded slice, a third type of NAL unit may encapsulate an RBSP for Supplemental Enhancement Information (SEI), and so on. A PPS is a syntax structure that may contain syntax elements that apply to zero or more entire coded pictures. NAL units that encapsulate RBSPs for video coding data (as opposed to RBSPs for parameter sets and SEI messages) may be referred to as video coding layer (VCL) NAL units. A NAL unit that encapsulates a coded slice may be referred to herein as a coded slice NAL unit. An RBSP for a coded slice may include a slice header and slice data.

HEVC and other video coding standards provide for various types of parameter sets. For example, a video parameter set (VPS) is a syntax structure comprising syntax elements that apply to zero or more entire coded video sequences (CVSs). A sequence parameter set (SPS) may contain information that applies to all slices of a CVS. An SPS may include a syntax element that identifies a VPS that is active when the SPS is active. Thus, the syntax elements of a VPS may be more generally applicable than the syntax elements of an SPS. A PPS is a syntax structure comprising syntax elements that apply to zero or more coded pictures. A PPS may include a syntax element that identifies an SPS that is active when the PPS is active. A slice header of a slice may include a syntax element that indicates a PPS that is active when the slice is being coded.

Video decoder 30 may receive a bitstream. In addition, video decoder 30 may parse the bitstream to obtain (e.g., decode) syntax elements from the bitstream. Video decoder 30 may reconstruct the pictures of the video data based at least in part on the syntax elements decoded from the bitstream. The process to reconstruct the video data may be generally reciprocal to the process performed by video encoder 20. For instance, video decoder 30 may use motion vectors of PUs to determine predictive blocks for the PUs of a current CU. Video decoder 30 may use a motion vector or motion vectors of PUs to generate predictive blocks for the PUs.

In addition, video decoder 30 may inverse quantize coefficient blocks associated with TUs of the current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive sample blocks for PUs of the current CU to corresponding samples of the transform blocks of the TUs of the current CU. By reconstructing the coding blocks for each CU of a picture, video decoder 30 may reconstruct the picture. Video decoder 30 may store decoded pictures in a decoded picture buffer for output and/or for use in decoding other pictures.

Video contents may be coded efficiently by reducing correlation among color components. One way to do this is to perform prediction. In a luma-based chroma prediction method that has been proposed during development of HEVC, chroma sample values are predicted from the reconstructed luma sample values. The prediction value can be generated using a least square fit method. This has been applied only to intra coded blocks. To further improve coding efficiency, it may also be desirable to reduce the correlation in inter coded blocks.

For inter frames (i.e., pictures coded using inter prediction), to reduce correlation for each color component, motion prediction is applied. In general, motion prediction involves the use of one or more motion vectors for a block to determine one or more predictive blocks for the block. The same motion vectors can be used for all color components, which can increase correlation among color components after motion prediction. To reduce the correlation among color components, one or more techniques of this disclosure may apply predictive coding after motion prediction.

First, in accordance with one or more techniques of this disclosure, the motion block (i.e., reference block) in a reference picture is located by the motion vector. In other words, a video coder may use a motion vector to determine a reference block in a reference picture. The residual signal of each color component is then generated by use of motion prediction. For instance, a video coder may generate a residual signal that comprises residual samples. Each of the residual samples may have a value equal to a difference between an original sample of a current block and a corresponding sample of the reference block. One of the components is set as the predictor component. For instance, video encoder 20 may set the luma component, Cb component, or Cr component as the predictor component. The residual signal of the predictor component is further compressed by use of transform/quantization and reconstructed using dequantization/inverse transform. The reconstructed residual sample values of the predictor component can be used (e.g., by a video coder) to predict residual sample values of the other color components.

Thus, in accordance with one or more techniques of this disclosure, video encoder 20 may generate a bitstream that comprises an encoded representation of video data. As part of generating the bitstream, video encoder 20 may generate, by use of motion prediction, a residual signal for a predictor color component. Furthermore, video encoder 20 may reconstruct the residual signal of the predictor color component. In at least some instances, video encoder 20 may use dequantization and an inverse transform to reconstruct the residual signal of the predictor color component. The reconstructed residual signal of the predictor color component may include reconstructed residual sample values of the predictor color component. Video encoder 20 may use reconstructed sample values of the predictor color component to predict sample values of the predicted color component. Furthermore, video encoder 20 may generate, by use of motion prediction, an initial residual signal for the predicted color component. Video encoder 20 may determine a final residual signal for the predicted color component such that each sample value in the final residual signal for the predicted color component is equal to a difference between one of the predicted sample values of the predicted color component and a corresponding sample of the initial residual signal of the predicted color component. Additionally, video encoder 20 may generate a coefficient block by transforming the final residual signal for the predicted color component. Video encoder 20 may include, in the bitstream, entropy-encoded data indicating quantized transform coefficients of the coefficient block. The predictor and predicted color components may be different ones of: a luma component, a Cb chroma component, and a Cr chroma component.

Similarly, video decoder 30 may decode a bitstream that includes an encoded representation of video data. As part of decoding the bitstream, video decoder 30 may reconstruct a residual signal of a predictor color component. The residual signal of the predictor color component may be generated using motion prediction. The reconstructed residual signal of the predictor color component may include reconstructed residual sample values of the predictor color component. In at least some instances, video decoder 30 may use dequantization and an inverse transform to reconstruct the residual signal of the predictor color component. Video decoder 30 may use the reconstructed residual sample values of the predictor color component to predict residual sample values of a predicted color component. Furthermore, video decoder 30 may add the predicted sample values of the predicted color component to corresponding samples generated by dequantizing and applying an inverse transform to a coefficient block. The bitstream may include entropy-encoded syntax elements indicating quantized transform coefficients of the coefficient block. In some examples, the term “color component” applies to luma and chroma (e.g., Cb, and Cr) components. The predictor and predicted color components may be different ones of: a luma component, a Cb chroma component, and a Cr chroma component.

In at least some examples, a video coder may generate a prediction sample value (i.e., a predicted sample value) of a predicted color component using a linear prediction from a reconstructed residual sample value of the predictor color component. For instance, a linear prediction can be used where the predicted sample value x′ is generated from the reconstructed residual sample value x as:

x′=ax+b,

where a is a scale factor and b is an offset. For instance, a video coder may determine a prediction sample value such that the prediction sample value is equal to x′=ax+b, where x′ is the prediction sample value and x is a reconstructed residual sample. The values a and b may be referred to herein as prediction parameters. In some examples, a and b can be calculated using a least square fit method applied to the motion block. For example, a and b can be calculated as:

a=Cov(Y_{ref},C_{ref})/Var(Y_{ref}),

b=Mean(C_{ref})−a·Mean(Y_{ref}),

where Cov( ) is a covariance function (e.g., Cov(x,y)=E[(x−E[x])(y−E[y])]), Var( ) is a variance function (e.g., Var(x)=E[(x−E[x])²]), and Mean( ) is a mean function (e.g., Mean(x)=E[x]). Y_{ref} and C_{ref} are the reference signals in the motion block for the predictor component and for the component to be predicted, respectively. The reference signals may comprise samples in (or interpolated from) a reference picture. After generation of the prediction value, the prediction value is subtracted from the current residual sample value, and the difference is further coded by transform and quantization.

In some examples, only one of these parameters can be used. For instance, a video coder may determine a prediction sample value x′ as:

x′=ax,

where x is a reconstructed residual sample value of the predictor color component, a is equal to Cov(Y_{ref}, C_{ref})/Var(Y_{ref}), Cov( ) is a covariance function, Var( ) is a variance function, Y_{ref} is a reference signal in a motion block for the predictor color component, and C_{ref} is a reference signal in the motion block for the predicted color component.

The prediction parameters (e.g., a and b in the examples above) can be calculated using the same reconstructed residual pixels at video encoder 20 and video decoder 30. There can be a separate parameter set for each color component to be predicted. In other words, a video coder (e.g., video encoder 20 or video decoder 30) may calculate different values for the prediction parameters for different ones of the color components.

In another example, video encoder 20 signals the calculated parameter values to video decoder 30 so that video decoder 30 can use the same parameter values. For instance, video encoder 20 may include, in a bitstream, data indicating the values of a and/or b described in the examples above or in other examples. The parameters can be quantized for efficient signaling. For instance, video encoder 20 may quantize the prediction parameter values and may include syntax elements indicating the quantized prediction parameter values in the bitstream. As the parameters are explicitly signaled, it may be possible to find the optimal parameter values using information not available at the decoder side. Thus, in some examples, video encoder 20 may include, in a bitstream, data indicating a value of a parameter. Similarly, video decoder 30 may obtain, from the bitstream, the value of the parameter. In these examples, video encoder 20 and video decoder 30 may determine a prediction sample value such that the prediction sample value is equal to x′=ax, where x′ is the prediction sample value, x is one of the reconstructed residual sample values of the predictor color component, and a is the parameter.

For example, instead of a motion block, the parameters can be calculated using the residual signals of the current block to be coded. More specifically, a and b can be found by applying the equations as below,

a=Cov(Yᵣₑₛ′,Cᵣₑₛ)/Var(Yᵣₑₛ′),

b=Mean(Cᵣₑₛ)−a·Mean(Yᵣₑₛ′),

where Cov( ) is a covariance function, Var( ) is a variance function, and Mean( ) is a mean function, Yᵣₑₛ′ is the reconstructed residual signal of the current block for the predictor component and Cᵣₑₛ is the residual signal in the current block for the component to be predicted. Thus, in this example, a video coder (e.g., video encoder 20 or video decoder 30) may determine a prediction sample value as x′=ax+b, where x′ is the prediction sample value, x is one of the reconstructed sample values of the predictor color component, a is equal to Cov(Yᵣₑₛ, Cᵣₑₛ)/Var(Yᵣₑₛ), and b is equal to Mean(Cᵣₑₛ)−a·Mean(Yᵣₑₛ). A video encoder may subtract the prediction sample value from a corresponding sample of the residual signal. The video encoder may transform and quantize the resulting sample value. A video decoder may add the prediction sample value to a corresponding residual value to reconstruct an original residual value. In some examples, instead of the reconstructed residual signal for the predictor color component, the residual signal can be used to reduce computational/implementation complexity. In some examples, to calculate the prediction parameters, all the sample values in the motion block for a coding unit or block can be used. Alternatively, in some examples, part of the sample values in the motion block for the CU or block can be used by subsampling or excluding zero values.

Furthermore, in some examples, to generate the prediction value, only one sample value in the predictor component can be used, which is collocated to the pixel to be predicted. Alternatively, multiple sample values in the predictor component can be used, where these samples are the collocated pixel and one or more of its neighbors.

This prediction feature can be applied to certain areas by providing a switch. For example, a flag to indicate turning this feature on and off can be coded into a slice header so that the prediction is applied or not applied (e.g., by the decoder) to the whole slice. Alternatively, the flag can be signaled at another level such as a sequence, a picture, an LCU, a CU, a PU, or a TU. When the flag is signaled at a sequence level, the flag may be signaled in an SPS. When the flag is signaled at a picture level, the flag may be signaled in a PPS.

Thus, as part of generating a bitstream, video encoder 20 may signal, in the bitstream, a flag to indicate whether to use the reconstructed residual samples of a predictor color component to predict residual sample values of a predicted color component. In some examples, video encoder 20 may code the flag at a sequence level (e.g., in a SPS). Similarly, as part of decoding a bitstream, video decoder 30 may obtain, from the bitstream, a flag to indicate whether to use reconstructed residual samples of a predictor color component to predict residual sample values of a predicted color component.

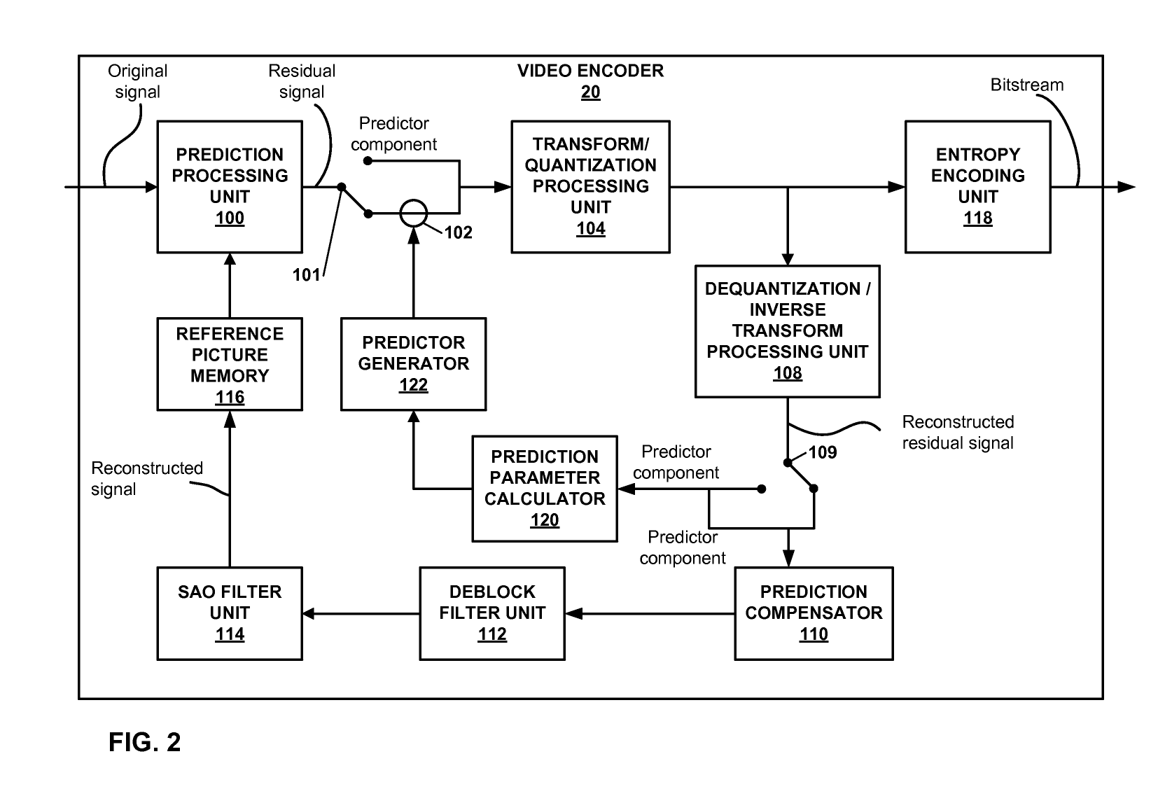

FIG. 2 is a block diagram illustrating an example video encoder 20 that may implement the techniques of this disclosure. FIG. 2 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

In the example of FIG. 2, video encoder 20 includes a prediction processing unit 100, a difference unit 102, a transform/quantization processing unit 104, an dequantization/inverse transform unit 108, a prediction compensator 110, a deblock filter unit 112, a sample adaptive offset (SAO) unit 114, a reference picture memory 116, an entropy encoding unit 118, a prediction parameter calculator 120, and a predictor generator 122. In other examples, video encoder 20 may include more, fewer, or different functional components.

Video encoder 20 may receive video data. Video encoder 20 may encode each CTU in a slice of a picture of the video data. Each of the CTUs may be associated with equally-sized luma coding tree blocks (CTBs) and corresponding CTBs of the picture. As part of encoding a CTU, prediction processing unit 100 may perform quad-tree partitioning to divide the CTBs of the CTU into progressively-smaller blocks. The smaller blocks may be coding blocks of CUs. For example, prediction processing unit 100 may partition a CTB associated with a CTU into four equally-sized sub-blocks, partition one or more of the sub-blocks into four equally-sized sub-sub-blocks, and so on.

Video encoder 20 may encode CUs of a CTU to generate encoded representations of the CUs (i.e., coded CUs). As part of encoding a CU, prediction processing unit 100 may partition the coding blocks associated with the CU among one or more PUs of the CU. Thus, each PU may be associated with a luma prediction block and corresponding chroma prediction blocks. Video encoder 20 and video decoder 30 may support PUs having various sizes. The size of a CU may refer to the size of the luma coding block of the CU and the size of a PU may refer to the size of a luma prediction block of the PU. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction. In some examples, chroma samples are sub-sampled relative to luma samples.

Prediction processing unit 100 may generate predictive data for a PU by performing inter prediction on each PU of a CU. The predictive data for the PU may include predictive blocks of the PU and motion information for the PU. Prediction processing unit 100 may perform different operations for a PU of a CU depending on whether the PU is in an I slice, a P slice, or a B slice. In an I slice, all PUs are intra predicted. Hence, if the PU is in an I slice, prediction processing unit 100 does not perform inter prediction on the PU. Thus, for video blocks encoded in I-mode, the predictive block is formed using spatial prediction from previously-encoded neighboring blocks within the same frame.

PUs in a P slice may be intra predicted or uni-directionally inter predicted. For instance, if a PU is in a P slice, prediction processing unit 100 may search the reference pictures in a list of reference pictures (e.g., “RefPicList0”) for a reference region for the PU. The reference region for the PU may be a region, within a reference picture, that contains sample blocks (i.e., motion blocks) that most closely corresponds to the prediction blocks of the PU. Prediction processing unit 100 may generate a reference index that indicates a position in RefPicList0 of the reference picture containing the reference region for the PU. In addition, prediction processing unit 100 may generate a motion vector that indicates a spatial displacement between a prediction block of the PU and a reference location associated with the reference region. For instance, the motion vector may be a two-dimensional vector that provides an offset from the coordinates in the current decoded picture to coordinates in a reference picture. Prediction processing unit 100 may output the reference index and the motion vector as the motion information of the PU. Prediction processing unit 100 may generate the predictive blocks of the PU based on actual or interpolated samples at the reference location indicated by the motion vector of the PU. The same motion vector may be used for luma and chroma predictive blocks.

PUs in a B slice may be intra predicted, uni-directionally inter predicted, or bi-directionally inter predicted. Hence, if a PU is in a B slice, the prediction processing unit 100 may perform uni-prediction or bi-prediction for the PU. To perform uni-prediction for the PU, prediction processing unit 100 may search the reference pictures of RefPicList0 or a second reference picture list (“RefPicList1”) for a reference region for the PU. Prediction processing unit 100 may output, as the motion information of the PU, a reference index that indicates a position in RefPicList0 or RefPicList1 of the reference picture that contains the reference region, a motion vector that indicates a spatial displacement between a sample block of the PU and a reference location associated with the reference region, and one or more prediction direction indicators that indicate whether the reference picture is in RefPicList0 or RefPicList1. Prediction processing unit 100 may generate the predictive blocks of the PU based at least in part on actual or interpolated samples at the reference region indicated by the motion vector of the PU.

To perform bi-directional inter prediction for a PU, prediction processing unit 100 may search the reference pictures in RefPicList0 for a reference region for the PU and may also search the reference pictures in RefPicList1 for another reference region for the PU. Prediction processing unit 100 may generate reference indexes that indicate positions in RefPicList0 and RefPicList1 of the reference pictures that contain the reference regions. In addition, prediction processing unit 100 may generate motion vectors that indicate spatial displacements between the reference locations associated with the reference regions and a sample block of the PU. The motion information of the PU may include the reference indexes and the motion vectors of the PU. Prediction processing unit 100 may generate the predictive blocks of the PU based at least in part on actual or interpolated samples at the reference region indicated by the motion vector of the PU. The same motion vectors may be used for luma and chroma predictive blocks.

Alternatively, prediction processing unit 100 may generate predictive data for a PU by performing intra prediction on the PU. The predictive data for the PU may include predictive blocks for the PU and various syntax elements. Prediction processing unit 100 may perform intra prediction on PUs in I slices, P slices, and B slices.

To perform intra prediction on a PU, prediction processing unit 100 may use multiple intra prediction modes to generate multiple sets of predictive data for the PU. Prediction processing unit 100 may generate a predictive block for the PU based on samples of neighboring PUs. The neighboring PUs may be above, above and to the right, above and to the left, or to the left of the PU, assuming a left-to-right, top-to-bottom encoding order for PUs, CUs, and CTUs. Prediction processing unit 100 may use various numbers of intra prediction modes, e.g., 33 directional intra prediction modes. In some examples, the number of intra prediction modes may depend on the size of the prediction blocks of the PU.

Prediction processing unit 100 may select the predictive data for PUs of a CU from among the predictive data generated by inter prediction and intra prediction. In some examples, prediction processing unit 100 selects the predictive data for the PUs of the CU based on rate/distortion metrics of the sets of predictive data. The predictive blocks of the selected predictive data may be referred to herein as the selected predictive blocks.

Prediction processing unit 100 may generate, based on the coding blocks (e.g., luma, Cb and Cr coding blocks) of a CU and the selected predictive blocks (e.g., luma, Cb and Cr blocks) of the PUs of the CU, a residual signal. The residual signal may include a residual luma block and residual Cb and Cr blocks of the CU. For instance, prediction processing unit 100 may generate the residual blocks of the CU such that each sample in the residual blocks has a value equal to a difference between a sample in a coding block of the CU and a corresponding sample in a corresponding selected predictive block of a PU of the CU. For each sample of a residual block in the residual signal, difference unit 102 may determine a difference between the sample and a sample predictor generated by predictor generator 122.

Transform/quantization processing unit 104 may perform quad-tree partitioning to partition the residual blocks of (i.e., associated with) a CU into transform blocks associated with TUs of the CU. Thus, a TU may comprise (e.g., be associated with) a luma transform block and two chroma transform blocks. The sizes and positions of the luma and chroma transform blocks of TUs of a CU may or may not be based on the sizes and positions of prediction blocks of the PUs of the CU. A quad-tree structure known as a “residual quad-tree” (RQT) may include nodes associated with each of the regions. The TUs of a CU may correspond to leaf nodes of the RQT.

Transform/quantization processing unit 104 may generate coefficient blocks for each TU of a CU by applying one or more transforms to the transform blocks of the TU. Transform/quantization processing unit 104 may apply various transforms to a transform block associated with a TU. For example, transform/quantization processing unit 104 may apply a discrete cosine transform (DCT), a directional transform, or a conceptually similar transform to a transform block. In some examples, transform/quantization processing unit 104 does not apply transforms to a transform block. In such examples (e.g., examples using a transform skip mode), the transform block may be treated as a coefficient block.

Transform/quantization processing unit 104 may quantize the transform coefficients in a coefficient block. The quantization process may reduce the bit depth associated with some or all of the transform coefficients. For example, an n-bit transform coefficient may be rounded down to an m-bit transform coefficient during quantization, where n is greater than m. Transform/quantization processing unit 104 may quantize a coefficient block associated with a TU of a CU based on a quantization parameter (Qα) value associated with the CU. Transform/quantization processing unit 104 may adjust the degree of quantization applied to the coefficient blocks associated with a CU by adjusting the QP value associated with the CU. Quantization may introduce loss of information; thus quantized transform coefficients may have lower precision than the original ones.

Dequantization/inverse transform processing unit 108 may apply inverse quantization and inverse transforms to a coefficient block, respectively, to reconstruct a residual block from the coefficient block. That is, dequantization/inverse transform processing unit 108 may reconstruct the residual signal for a block. Prediction compensator 110 may add the reconstructed residual block to corresponding samples from one or more predictive blocks generated by prediction processing unit 100 to produce a reconstructed transform block associated with a TU. In some examples, prediction compensator 110 may determine (e.g., using a linear prediction), based on the reconstructed residual signal for the predictor color component, predicted sample values for samples of a predicted color component. Prediction compensator 110 may add the predicted sample values to corresponding samples of the reconstructed residual signal for the predicted color component to reconstruct the sample values of the residual signal for the predicted color component. By reconstructing transform blocks for each TU of a CU in this way, video encoder 20 may reconstruct the coding blocks of the CU.

Deblock filter unit 112 may perform one or more deblocking operations to reduce blocking artifacts in the coding blocks of a CU. SAO filter unit 114 may apply SAO operations to the coding blocks of the CU. Reference picture memory 116 may store the reconstructed coding blocks after SAO filter unit 114 performs the one or more SAO operations on the reconstructed coding blocks. Prediction processing unit 100 may use a reference picture that contains the reconstructed coding blocks to perform inter prediction on PUs of other pictures. Furthermore, prediction processing unit 100 may use reconstructed coding blocks in reference picture memory 116 to perform intra prediction on other PUs in the same picture as the CU.

Entropy encoding unit 118 may receive data from other functional components of video encoder 20. For example, entropy encoding unit 118 may receive coefficient blocks from quantization unit 106 and may receive syntax elements from prediction processing unit 100. Entropy encoding unit 118 may perform one or more entropy encoding operations on the data to generate entropy-encoded data. For example, entropy encoding unit 118 may perform a CABAC operation, a context-adaptive variable length coding (CAVLC) operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 20 may output a bitstream that includes entropy-encoded data generated by entropy encoding unit 118. For instance, the bitstream may include data that represents a RQT for a CU. The bitstream may also include syntax elements that are not entropy encoded.

As described above, video encoder 20 may use the residual sample values of a predictor component (e.g., luma, Cb, or Cr) to predict sample values of other color components. As an illustration, video encoder 20 may use the residual sample values of the luma component as a predictor component to predict sample values (e.g., residual sample values) of a Cr color component, or a Cb color component. In the example of FIG. 2, switch 101 controls, based on whether a residual signal generated by prediction processing unit 100 is for a predictor color component or a predicted color component, whether the residual signal is provided to difference unit 102. As an illustration, switch 101 may provide the luma residual signal for the luma component, but instead provide a predictor residual signal from predictor generator 122 for another color component. For example, the luma residual may be used as a residual predictor for the residual of the Cr and/or Cb color component. As shown in the example of FIG. 2, prediction compensator 110 may receive reconstructed residual signals for both predictor and predicted color components. Furthermore, in the example of FIG. 2, switch 109 provides reconstructed residual signals for the predictor color component to prediction parameter calculator 120, but does not provide reconstructed residual signaled for predicted color components to prediction parameter calculator 120.

Prediction parameter calculator 120 may process a reconstructed residual signal to determine prediction parameters, such as the prediction parameters a and b described in other examples of this disclosure. Predictor generator 122 may determine predictor sample values (i.e., ax+b) based on prediction parameters a and b. Difference unit 102 may determine final residual signals for predicted color components by subtracting values of residual samples in residual signals from corresponding predictor sample values determined by predictor generator 122.

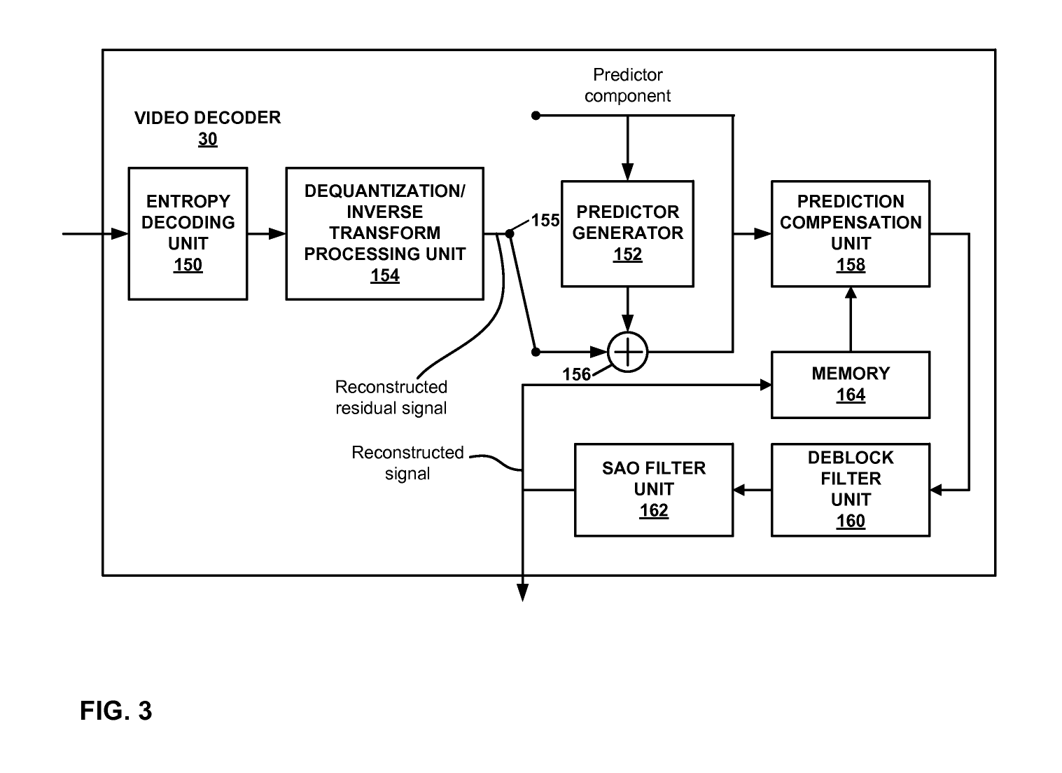

FIG. 3 is a block diagram illustrating an example video decoder 30 that may implement the techniques described in this disclosure. FIG. 3 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In the example of FIG. 3, video decoder 30 includes an entropy decoding unit 150, a predictor generator 152, a dequantization/inverse transform processing unit 154, a reconstruction unit 156, a prediction compensation unit 158, a deblock filter unit 160, a SAO filter unit 162, and a memory 164. In other examples, video decoder 30 may include more, fewer, or different functional components.

Entropy decoding unit 150 may receive NAL units and may parse the NAL units to obtain syntax elements. Entropy decoding unit 150 may entropy decode entropy-encoded syntax elements in the NAL units. Predictor generator 152, dequantization/inverse transform processing unit 154, reconstruction unit 156, deblock filter unit 160 and SAO filter unit 162 may generate decoded video data based on the syntax elements extracted from the bitstream.

The NAL units of the bitstream may include coded slice NAL units. As part of decoding the bitstream, entropy decoding unit 150 may extract and entropy decode syntax elements from the coded slice NAL units. Each of the coded slices may include a slice header and slice data. The slice header may contain syntax elements pertaining to a slice. The syntax elements in the slice header may include a syntax element that identifies a PPS associated with a picture that contains the slice.

In addition to decoding syntax elements from the bitstream, video decoder 30 may perform reconstruction operations on CUs. To perform the reconstruction operation on a CU, video decoder 30 may perform a reconstruction operation on each TU of the CU. By performing the reconstruction operation for each TU of the CU, video decoder 30 may reconstruct residual blocks of the CU.

As part of performing a reconstruction operation on a TU of a CU, dequantization/inverse transform processing unit 154 may inverse quantize, i.e., de-quantize, coefficient blocks associated with the TU. Dequantization/inverse transform processing unit 154 may use a QP value associated with the CU of the TU to determine a degree of quantization and, likewise, a degree of inverse quantization for dequantization/inverse transform processing unit 154 to apply.

In the example of FIG. 3, switch 155 controls whether predictor generator 152 or reconstruction unit 156 receives a reconstructed residual signal generated by dequantization/inverse transform processing unit 154. Particularly, switch 155 provides reconstructed residual signals for the predictor color component to predictor generator 152 and provides reconstructed residual signals for predicted color components to reconstruction unit 156. Predictor generator 152 may determine predictor components as described elsewhere in this disclosure. That is, predictor generator 152 may determine, based on samples of a predictor color component, residual samples of a different color component. Reconstruction unit 156 may add the predictor components generated by predictor generator 152 to corresponding samples generated by dequantization/inverse transform processing unit 154.

After dequantization/inverse transform processing unit 154 inverse quantizes a coefficient block, dequantization/inverse transform processing unit 154 may apply one or more inverse transforms to the coefficient block in order to generate a residual block associated with the TU. For example, dequantization/inverse transform processing unit 154 may apply an inverse DCT, an inverse integer transform, an inverse Karhunen-Loeve transform (KLT), an inverse rotational transform, an inverse directional transform, or another inverse transform to the coefficient block.

If a PU is encoded using intra prediction, prediction compensation unit 158 may perform intra prediction to generate predictive blocks for the PU. Prediction compensation unit 158 may use an intra prediction mode to generate the predictive luma, Cb and Cr blocks for the PU based on the prediction blocks of spatially-neighboring PUs. Prediction compensation unit 158 may determine the intra prediction mode for the PU based on one or more syntax elements obtained (e.g., decoded) from the bitstream.

Prediction compensation unit 158 may construct a first reference picture list (RefPicList0) and a second reference picture list (RefPicList1) based on syntax elements extracted from the bitstream. Furthermore, if a PU is encoded using inter prediction, prediction compensation unit 158 may extract motion information for the PU. Prediction compensation unit 158 may determine, based on the motion information of the PU, reference blocks (i.e., motion blocks) for the PU. Prediction compensation unit 158 may generate, based on samples of the one or more reference blocks for the PU, predictive luma, Cb and Cr blocks for the PU.

Furthermore, prediction compensation unit 158 may use the transform blocks (e.g., luma, Cb and Cr transform blocks) of TUs of a CU and the predictive blocks (e.g., luma, Cb and Cr blocks) of the PUs of the CU, i.e., either intra-prediction data or inter-prediction data, as applicable, to reconstruct the coding blocks (e.g., luma, Cb and Cr coding blocks) of the CU. For example, prediction compensation unit 158 may add samples of the luma, Cb and Cr transform blocks to corresponding samples of the predictive luma, Cb and Cr blocks to reconstruct the luma, Cb and Cr coding blocks of the CU.

Deblock filter unit 160 may perform a deblocking operation to reduce blocking artifacts associated with the coding blocks (e.g., luma, Cb and Cr coding blocks) of the CU. SAO filter unit 162 may perform SAO filter operations on the coding blocks of the CU. Video decoder 30 may store the coding blocks (e.g., luma, Cb and Cr coding blocks) of the CU in memory 164. Memory 164 may provide reference pictures for subsequent motion compensation, intra prediction, and presentation on a display device, such as display device 32 of FIG. 1. For instance, video decoder 30 may perform, based on the luma, Cb and Cr blocks in memory 162 (i.e., decoded picture buffer), intra prediction or inter prediction operations on PUs of other CUs. In this way, video decoder 30 may obtain, from the bitstream, transform coefficient levels of a coefficient block, inverse quantize the transform coefficient levels, apply a transform to the transform coefficient levels to generate a transform block. Furthermore, video decoder 30 may generate, based at least in part on the transform block, a coding block. Video decoder 30 may output the coding block for display.

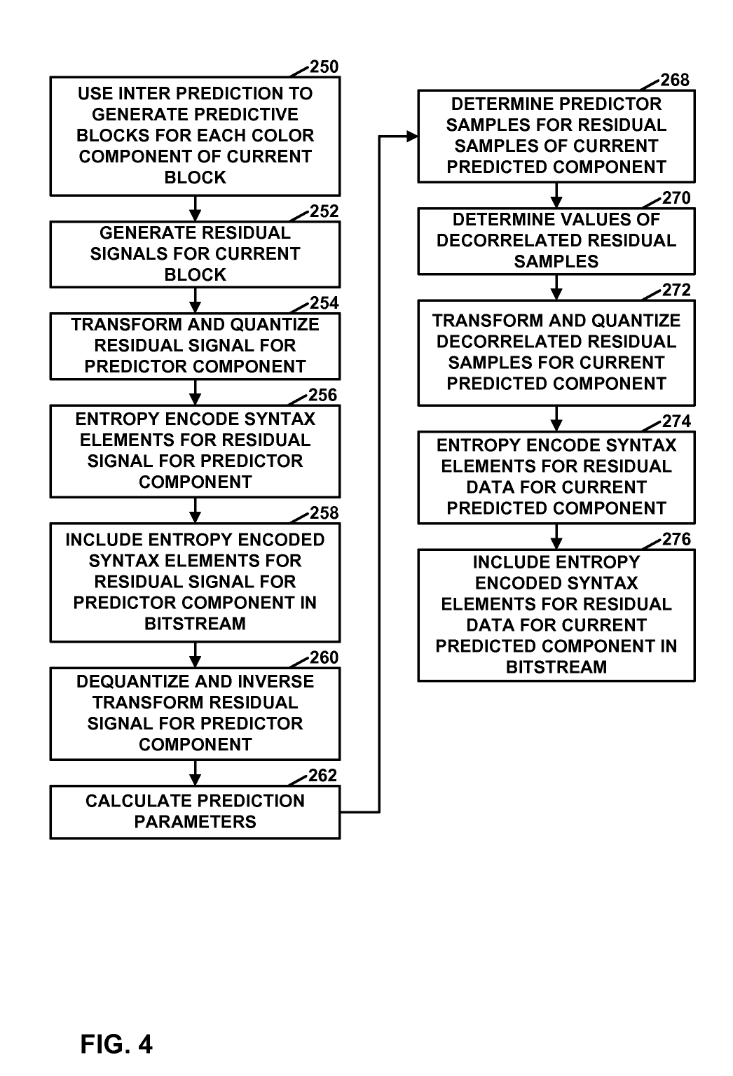

FIG. 4 is a flowchart illustrating an example operation of video encoder 20, in accordance with one or more techniques of this disclosure. FIG. 4 is presented as an example. Other examples may include more, fewer, or different actions. Furthermore, FIG. 4 is described with reference to FIG. 2. However, the operation illustrated in FIG. 4 may be performed in environments different than that shown in the example of FIG. 2.

In the example of FIG. 4, prediction processing unit 100 of video encoder 20 may use inter prediction to generate predictive blocks for each color component (e.g., luma, Cb, Cr, etc.) of a current block (250). For example, the current block may be a CU and prediction processing unit 100 may use inter prediction to generate predictive blocks for each PU of the CU. In various examples, prediction processing unit 100 may use temporal inter prediction and/or inter-view prediction to generate the predictive blocks.

Furthermore, prediction processing unit 100 may generate residual signals for the current block (252). The residual signals for the current block may include a residual signal for each of the color components. The residual signal for a color component may comprise residual samples, each having a value equal to a difference between an original value of a sample and a value of a corresponding sample in a predictive block for the color component. For example, the current block may be a CU and prediction processing unit 100 may, for each respective sample of a coding block of the CU, determine a value of a corresponding residual sample. In this example, the value of the corresponding residual sample may be equal to the value of the respective sample minus a value of a corresponding sample in a predictive block of a PU of the CU.

The color components may include a predictor color component and at least one predicted color component. In some examples, the luma component is the predictor color component and Cb and Cr are the predicted color components. In other examples, a chroma color component (e.g., Cb or Cr) is the predictor color component and the luma component is the predicted color component. Transform/quantization processing unit 104 of video encoder 20 may transform and quantize the residual signal for the predictor color component (254). For example, the current block may be a CU and transform/quantization processing unit 104 may partition the residual signal for the predictor color component into one or more transform blocks. In this example, each of the transform blocks corresponds to a TU for the CU. Furthermore, in this example, transform/quantization processing unit 104 may apply a transform (e.g., a discrete cosine transform) to each of the transform blocks to generate transform coefficient blocks. Furthermore, in this example, transform/quantization processing unit 104 may quantize transform coefficients in the transform coefficient blocks.

Additionally, in the example of FIG. 4, entropy encoding unit 118 may entropy encode syntax elements for the transformed and quantized residual signal for the predictor color component (256). For example, the current block may be a CU and entropy encoding unit 118 may apply CABAC encoding to particular syntax elements that represent transform coefficients of transform coefficient blocks corresponding to TUs of the CU. Entropy encoding unit 118 may include the entropy-encoded syntax elements for the residual signal for the predictor component in a bitstream (258). The bitstream may comprise an encoded representation of video data that includes the current block.

In the example of FIG. 4, dequantization/inverse transform processing unit 108 may dequantize and inverse transform the quantized and transformed residual signal for the predictor color component (260). In this way, dequantization/inverse transform processing unit 108 may generate a reconstructed residual signal for the predictor color component. For example, the current block may be a CU and dequantization/inverse transform processing unit 108 may dequantize transform coefficients of transform coefficient blocks corresponding to TUs of the CU. Furthermore, in this example, dequantization/inverse transform processing unit 108 may apply an inverse transform (e.g., an inverse discrete cosine transform) to the dequantized transform coefficient blocks, thereby reconstructing transform blocks for the TUs of the CU. In this example, the reconstructed residual signal for the predictor color component may comprise the reconstructed transform blocks.

Furthermore, in the example of FIG. 4, prediction parameter calculator 120 may calculate one or more prediction parameters (262). In some examples, prediction parameter calculator 120 may calculate the one or more prediction parameters based on the reconstructed residual signal for the predictor component.

In some examples, prediction parameter calculator 120 calculates a prediction parameter a. In some such examples, the prediction parameter a is equal to Cov(Y_{ref}, C_{ref})/Var(Y_{ref}), where Cov( ) is a covariance function, Var( ) is a variance function, and Y_{ref} and C_{ref} are the reference signal in the motion block for the predictor component and for the component to be predicted, respectively. In other examples, the prediction parameter a is equal to Cov(Yᵣₑₛ′, Cᵣₑₛ)/Var(Yᵣₑₛ′), where Cov( ) is a covariance function, Var( ) is a variance function, Yᵣₑₛ′ is the reconstructed residual signal of the current block for the predictor component, and Cᵣₑₛ is the residual signal in the current block for the component to be predicted.

Furthermore, in some examples, a video coder may determine a predictor sample value as x′=ax+b. In some such examples, prediction parameter calculator 120 calculates a prediction parameter b. In some such examples, prediction parameter calculator 120 may calculate the prediction parameter b such that the prediction parameter b is equal to Mean(C_{ref})−a·Mean(Y_{ref}), where Mean( ) is a mean function, Y_{ref} and C_{ref} are the reference signal in the motion block for the predictor component and for the component to be predicted, respectively. In other examples, prediction parameter calculator 120 may calculate the prediction parameter b such that the prediction parameter b is equal to Mean(Cᵣₑₛ)−a·Mean(Yᵣₑₛ′), where Mean( ) is a mean function, Yᵣₑₛ′ is the reconstructed residual signal of the current block for the predictor component, and Cᵣₑₛ is the residual signal in the current block for the component to be predicted.

In the example of FIG. 4, video encoder 20 may perform actions (268) through (276) for each of the residual signals of the current block (e.g., for a luma residual signal, a Cb residual signal, and a Cr residual signal). Thus, for ease of explanation, this disclosure may refer to the residual signal upon which video encoder 20 is currently performing actions (268) through (276) as the residual signal for the current predicted color component. Accordingly, in the example of FIG. 4, predictor generator 122 of video encoder 20 may determine predictor samples for each residual sample of the residual signal for the current predicted color component (268). In some examples, predictor generator 122 determines a predictor sample x′ such that x′ is equal to ax, where a is a prediction parameter calculated by prediction parameter calculator 120 and x is a reconstructed residual sample in the reconstructed residual signal for the predictor color component. Furthermore, in some examples, predictor generator 122 determines a predictor sample x′ such that x′ is equal to ax+b, where a and b are prediction parameters calculated by prediction parameter calculator 120 and x is a reconstructed residual sample in the reconstructed residual signal for the predictor color component. In some examples, x is collocated with x′.

Additionally, in the example of FIG. 4, difference unit 102 of video encoder 20 may determine values of decorrelated residual samples for the current predicted color component (270). Difference unit 102 may determine, based at least in part on the predictor samples generated by predictor generator, the values of the decorrelated residual samples for the current predicted color component. In some examples, difference unit 102 may determine the value of a decorrelated residual sample such that the value of the decorrelated residual sample is equal to a difference between a value of a residual sample in the residual signal for the current predicted color component and a value of a corresponding predictor sample generated by predictor generator 122. In this way, difference unit 102 may generate a decorrelated residual signal for the current predicted color component. The decorrelated residual signal for the current predicted color component may comprise the decorrelated samples determined by difference unit 102.

Transform/quantization processing unit 104 of video encoder 20 may transform and quantize the decorrelated residual signal for the current predicted color component (272). For example, the current block may be a CU and transform/quantization processing unit 104 may partition the decorrelated residual signal for the current predicted color component into one or more transform blocks. In this example, each of the transform blocks corresponds to a TU for the CU. Furthermore, in this example, transform/quantization processing unit 104 may apply a transform (e.g., a discrete cosine transform) to each of the transform blocks to generate transform coefficient blocks. Furthermore, in this example, transform/quantization processing unit 104 may quantize transform coefficients in the transform coefficient blocks.

Additionally, in the example of FIG. 4, entropy encoding unit 118 may entropy encode syntax elements for the transformed and quantized decorrelated residual signal for the current predicted color component (274). For example, the current block may be a CU and entropy encoding unit 118 may apply CABAC encoding to particular syntax elements that represent transform coefficients of transform coefficient blocks corresponding to TUs of the CU. Entropy encoding unit 118 may include the entropy-encoded syntax elements for the decorrelated residual signal for the current predicted component in the bitstream (276).

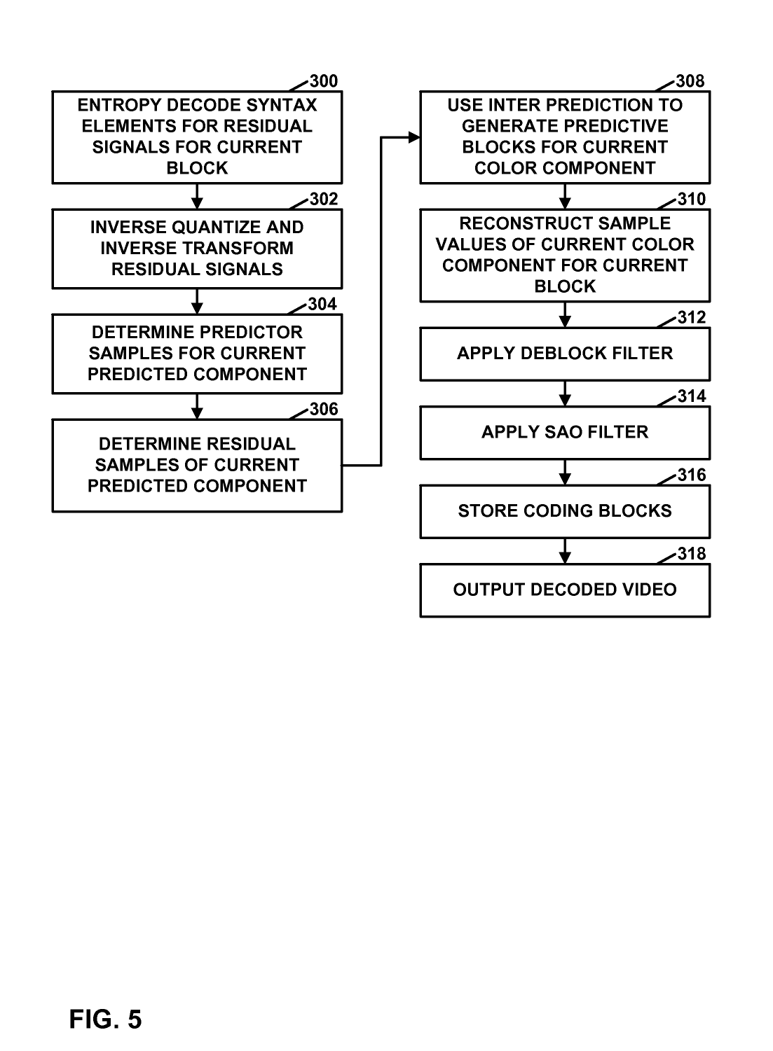

FIG. 5 is a flowchart illustrating an example operation of video decoder 30, in accordance with one or more techniques of this disclosure. FIG. 5 is presented as an example. Other examples may include more, fewer, or different actions. Furthermore, FIG. 5 is described with reference to FIG. 3. However, the operation illustrated in FIG. 5 may be performed in environments different than that shown in the example of FIG. 3.

In the example of FIG. 5, entropy decoding unit 150 of video decoder 30 may entropy decode syntax elements for residual signals for a current block (300). In some examples, the current block may be a CU, PU, macroblock, macroblock partition, or another type of video block. The residual signals for the current block may include a residual signal for a predictor color component and one or more decorrelated residual signals for one or more predicted color components. The residual signals for the current block may comprise data representing residual samples of the current block. For instance, in some examples, the data representing residual samples of the current block may comprise transform coefficients.

Furthermore, in the example of FIG. 5, dequantization/inverse transform processing unit 154 of video decoder 30 may dequantize and inverse transform the residual signals for the current block (302). In this way, dequantization/inverse transform processing unit 108 may generate reconstructed residual signals for the current block. For example, the current block may be a CU and dequantization/inverse transform processing unit 108 may dequantize transform coefficients of transform coefficient blocks corresponding to TUs of the CU. Furthermore, in this example, dequantization/inverse transform processing unit 108 may apply an inverse transform (e.g., an inverse discrete cosine transform) to the dequantized transform coefficient blocks, thereby reconstructing transform blocks for the TUs of the CU. In this example, the reconstructed residual signal for a color component may comprise the reconstructed transform blocks.

Video decoder 30 may perform actions (304) and (306) with regard to the reconstructed residual signals for each of the predicted color components. Thus, for ease of explanation, this disclosure may refer to the reconstructed residual signal upon which video decoder 30 is currently performing actions (304) and (306) as the reconstructed residual signal for the current predicted color component. Accordingly, in the example of FIG. 5, predictor generator 152 of video decoder 30 may determine predictor samples for each residual sample of the reconstructed residual signal for the current predicted color component (304). In some examples, predictor generator 152 determines a predictor sample x′ such that x′ is equal to ax, where a is a prediction parameter and x is a reconstructed residual sample in the reconstructed residual signal for the predictor color component. Furthermore, in some examples, predictor generator 152 determines a predictor sample x′ such that x′ is equal to ax+b, where a and b are prediction parameters and x is a reconstructed residual sample in the reconstructed residual signal for the predictor color component. In some examples, x is collocated with x′.

Additionally, in the example of FIG. 5, reconstruction unit 156 may determine values of residual samples for the current predicted color component (306). Reconstruction unit 156 may determine, based at least in part on the predictor samples generated by predictor generator 152, the values of the residual samples for the current predicted color component. In some examples, reconstruction unit 156 may determine the value of a residual sample such that the value of the residual sample is equal to a sum of a value of a residual sample in the reconstructed residual signal for the current predicted color component and a value of a corresponding predictor sample generated by predictor generator 152. In this way, difference unit 102 may generate a reconstructed residual signal for the current predicted color component. The reconstructed residual signal for the current predicted color component may comprise the samples determined by reconstruction unit 156.

Video decoder 30 may perform actions (308) through (318) of FIG. 5 with respect to each of the color components, including the predictor color component and predicted color components. Accordingly, for ease of explanation, this disclosure may refer to the color component for which video decoder 30 is performing actions (308) through (318) as the current color component.

In the example of FIG. 5, prediction compensation unit 158 of video decoder 30 may use inter prediction to generate one or more predictive blocks for the current color component (308). For example, if the current block is a CU, prediction compensation unit 158 may use inter prediction to generate predictive blocks for PUs of the CU. In this example, the predictive blocks may comprise samples of the current color component. In some examples, prediction compensation unit 158 may use temporal inter prediction or inter-view prediction to generate the predictive blocks. As shown in the example of FIG. 3, prediction compensation unit 158 may use video data stored in memory 164 when using inter prediction to generate the predictive blocks.

Furthermore, in the example of FIG. 5, prediction compensation unit 158 may reconstruct sample values of the current color component for the current block (310). For example, prediction compensation unit 158 may reconstruct a sample value of the current block such that the sample value is equal to a sum of a corresponding sample in one of the predictive blocks (e.g., generated using intra or inter prediction) and a corresponding sample in the reconstructed residual signal for the current color component (e.g., a reconstructed residual signal for a predicted color component). In some examples where the current block is a CU, prediction compensation unit 158 may determine values of samples in a coding block for the current color component by adding a corresponding sample in a prediction block for a PU of the CU and a corresponding sample in a transform block of a TU of the CU.

In the example of FIG. 5, deblock filter unit 160 of video decoder 30 may apply a deblock filter to the reconstructed sample values of the current color component for the current block (312). Furthermore, SAO filter unit 162 of video decoder 30 may apply an SAO filter to the reconstructed sample values of the current color component for the current block (314). This disclosure may refer to the resulting data as the reconstructed signal for the current color component. Memory 164 of video decoder 30 may store the reconstructed signal for the current color component (316). Furthermore, video decoder 30 may output the reconstructed signal for the current color component (318).

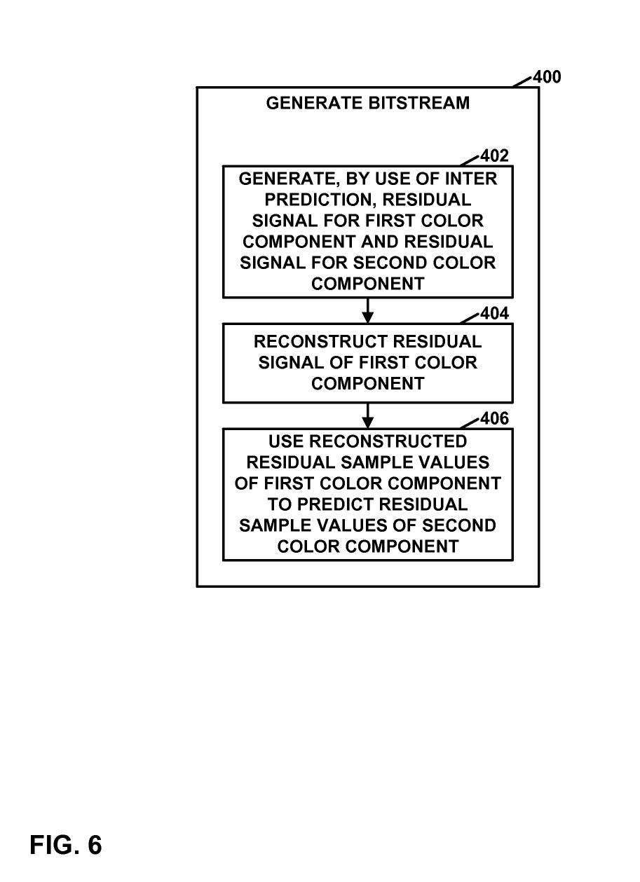

FIG. 6 is a flowchart illustrating an example operation of a video encoder, in accordance with one or more techniques of this disclosure. FIG. 6 is presented as an example. Other examples may include more, fewer, or different actions.

In the example of FIG. 6, video encoder 20 generates a bitstream that comprises an encoded representation of video data (400). As part of generating the bitstream, video encoder 20 may generate, by use of motion prediction, a residual signal for a first color component (e.g., a predictor color component) and a residual signal for a second color component (e.g., a predicted color component) (402). For example, when video encoder 20 uses motion prediction to generate the residual signal for the first color component and the second color component, video encoder 20 may determine a predictive block of the first color component and a predictive block of the second color component using uni-directional inter prediction or bi-directional inter prediction. Examples of uni-directional and bi-directional inter prediction are described elsewhere in this disclosure. In this example, video encoder 20 may determine the residual signal for the first color component as a difference between samples of the block for the first color component and samples of the predictive block for the first color component. As described elsewhere in this disclosure, video encoder 20 may use the reconstructed residual samples of the first color component to determine predicted sample values of the second color component (e.g., using a linear interpolation). Furthermore, video encoder 20 may determine the residual signal for the second color component as a difference between samples of the block for the second color component and samples of the predictive block for the second color component. In this example, video encoder 20 may subtract samples of the residual signal for the second color component from corresponding predicted sample values of the second color component.

Furthermore, video encoder 20 may reconstruct the residual signal of the first color component (404). The reconstructed residual signal of the first color component may include reconstructed residual sample values of the first color component. Video encoder 20 may use the reconstructed residual sample values of the first color component to predict residual sample values of the second color component (406).

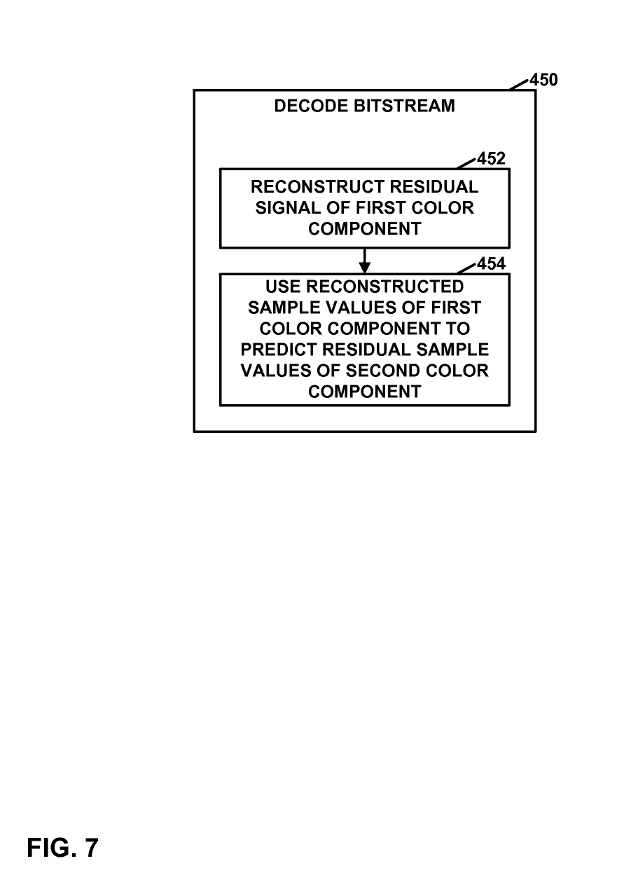

FIG. 7 is a flowchart illustrating an example operation of a video decoder, in accordance with one or more techniques of this disclosure. FIG. 7 is presented as an example. Other examples may include more, fewer, or different actions.

In the example of FIG. 7, video decoder 30 decodes a bitstream that includes an encoded representation of the video data (450). As part of decoding the bitstream, video decoder 30 may reconstruct a residual signal of a first color component (e.g., a predictor color component) (452). Reconstructing a residual signal may involve dequantizing and applying an inverse transform to coefficient values for the first color component to determine the residual signal. The reconstructed residual signal of the first color component may include reconstructed residual sample values of the first color component. The residual signal of the first color component may be generated using motion prediction. For example, the residual signal for the first color component may be generated by a video encoder using motion prediction and signaled in the bitstream. To generate the residual signal for the first color component using motion prediction, the video encoder may determine a predictive block of the first color component using uni-directional inter prediction or bi-directional inter prediction. Examples of uni-directional and bi-directional inter prediction are described elsewhere in this disclosure. In this example, the video encoder may determine the residual signal for the first color component as a difference between samples of the block for the first color component and samples of the predictive block for the first color component. The video encoder may transform and quantize the residual signal for the first color component and signal the resulting data in the bitstream.

In the example of FIG. 7, video decoder 30 may use reconstructed residual sample values of the first color component to predict residual sample values of a second, different color component (454). For example, when video decoder 30 uses reconstructed residual sample values of the first color component to predict residual sample values of the second color component, video decoder 30 may use reconstructed residual samples of the first color component to determine predicted sample values of the second color component (e.g., using linear prediction). In this example, video decoder 30 may add predicted sample values of the second color component to signaled values of the second color component to reconstruct the residual signal for the second color component.

The following paragraphs provide additional examples of this disclosure.

### Example 1

A method of decoding video data, the method comprising: obtaining, from a bitstream, syntax elements representing a first residual block for a prediction unit (PU) and a second residual block for the PU, the first residual block comprising residual samples of a first color component, the second residual block comprising residual samples of a second color component, the second color component being different than the first color component; determining, based at least in part on a motion vector for the PU, a first motion block for the PU and a second motion block for the PU, the first motion block for the PU comprising samples of the first color component, the second motion block for the PU comprising samples of the second color component; generating, based at least in part on the first residual block for the PU and the first motion block for the PU, a first reconstructed block for the PU, the first reconstructed block comprising samples of the first color component; determining, based at least in part on the second residual block for the PU, the second motion block for the PU and the first reconstructed block for the PU, a second reconstructed block for the PU, the second reconstructed block for the PU comprising samples of the second color component; and outputting video based on the first and second reconstructed blocks for the PU.

### Example 2

The method of example 1, wherein determining the second reconstructed block for the PU comprises: determining, based at least in part on a sample in the second residual block and a sample in the second motion block, an initial sample; and determining a final sample in the second reconstructed block for the PU as y′=y+x′, where y′ is the final sample, y is the initial sample, and x′=ax, where x is a residual sample in the first residual block, a is equal to Cov(Y_{ref}, C_{ref})/Var(Y_{ref}), where Cov( ) is a covariance, Var( ) is a variance, Y_{ref} is a sample in the first motion block, and C_{ref} is the sample in the second motion block.

### Example 3

The method of example 1, wherein determining the second reconstructed block for the PU comprises: determining, based at least in part on a sample in the second residual block and a sample in the second motion block, an initial sample; and determining a final sample in the second reconstructed block for the PU as y′=y+x′, where y′ is the final sample, y is the initial sample, and x′=ax+b, where x is a residual sample in the first residual block, a is equal to Cov(Yᵣₑₛ, Cᵣₑₛ)/Var(Yᵣₑₛ), and b is equal to Mean(Cᵣₑₛ)−a·Mean(Yᵣₑₛ), where Cov( ) is a covariance, Var( ) is a variance, Yᵣₑₛ is a first residual sample, and Cᵣₑₛ is the second residual sample.

### Example 4

The method of examples 2 or 3, further comprising obtaining, from a bitstream, the values a and b.

### Example 5

The method of example 1, wherein the first and second color components are different ones of: a luma component, a Cb chroma component, and a Cr chroma component.

### Example 6

A method of decoding video data, the method comprising any of examples 1-5.

### Example 7

A video decoding device comprising one or more processors configured to perform the methods of any of examples 1-5.

### Example 8

A video decoding device comprising means for performing the methods of any of examples 1-5.

### Example 9

A computer-readable storage medium having instructions stored thereon that, when executed, configure a video decoder to perform the methods of any of examples 1-5.

### Example 10

A method of encoding video data, the method comprising: determining a motion vector for the PU; determining, based at least in part on the motion vector for the PU, a first motion block for the PU and a second motion block for the PU, the first motion block for the PU comprising samples of a first color component, the second motion block for the PU comprising samples of a second color component, the second color component being different than the first color component; generating, based at least in part on a first original block for the PU and the first motion block for the PU, a first residual block for the PU, the first original block for the PU and the first residual block for the PU comprising samples of the first color component; determining, based at least in part on a second original block for the PU, the second motion block for the PU and the first residual block for the PU, a second residual block for the PU, the second original block for the PU and the second residual block for the PU comprising samples of the second color component; and outputting a bitstream that includes an encoded representation of the first residual block for the PU and an encoded representation of the second residual block for the PU.

### Example 11

The method of example 10, wherein determining the second residual block for the PU comprises: determining, based at least in part on a sample in the second original block and a corresponding sample in the second motion block, an initial residual sample; and determining a final residual sample in the second residual block for the PU as y′=y−x′, where y′ is the final residual sample, y is the initial residual sample, and x′=ax, where x is a sample in the first residual block, and a is equal to Cov(Y_{ref}, C_{ref})/Var(Y_{ref}), wherein Cov( ) is a covariance, Var( ) is a variance, Y_{ref} is a sample in the first motion block, and C_{ref} is the sample in the second motion block.

### Example 12

The method of example 10, wherein determining the second residual block for the PU comprises: determining, based at least in part on a sample in the second residual block and a sample in the second motion block, an initial residual sample; and determining a final residual sample in the second residual block for the PU as y′=y−x′, where y′ is the final residual sample, y is the initial residual sample, and x′=ax+b, where x is a residual sample in the first residual block, a is equal to Cov(Yᵣₑₛ, Cᵣₑₛ)/Var(Yᵣₑₛ), and b is equal to Mean(Cᵣₑₛ)−a·Mean(Yᵣₑₛ), where Cov( ) is a covariance, Var( ) is a variance, Yᵣₑₛ is a sample in the first residual sample, and C_{ref} is a second residual sample.

### Example 13

The method of examples 11 or 12, wherein the bitstream comprises encoded representations of the values a and b.

### Example 14

The method of example 10, wherein the first and second color components are different ones of: a luma component, a Cb chroma component, and a Cr chroma component.

### Example 15

A method of decoding video data, the method comprising any of examples 10-14.

### Example 16

A video decoding device comprising one or more processors configured to perform the methods of any of examples 10-14.

### Example 17

A video decoding device comprising means for performing the methods of any of examples 10-14.

### Example 18

A computer-readable storage medium having instructions stored thereon that, when executed, configure a video decoder to perform the methods of any of examples 10-14.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
decoding a bitstream that includes an encoded representation of the video data, wherein decoding the bitstream comprises:
reconstructing a residual signal of a first color component, wherein the residual signal of the first color component is generated using motion prediction, the reconstructed residual signal of the first color component including reconstructed residual sample values of the first color component; and
using the reconstructed residual sample values of the first color component to predict residual sample values of a second, different color component.

2. The method of claim 1, wherein the first and second color components are different ones of: a luma component, a Cb chroma component, and a Cr chroma component.

3. The method of claim 1, further comprising adding the predicted residual sample values of the second color component to corresponding samples generated by dequantizing and applying an inverse transform to a coefficient block, wherein the bitstream includes entropy-encoded syntax elements indicating quantized transform coefficients of the coefficient block.

4. The method of claim 1, wherein reconstructing the residual signal of the first color component comprises using dequantization and an inverse transform to reconstruct the residual signal of the first color component.

5. The method of claim 1, wherein using the reconstructed residual sample values of the first color component to predict the residual sample values of the second color component comprises generating a prediction sample value of the second color component using a linear prediction from a reconstructed residual sample value of the first color component.

6. The method of claim 5, wherein generating the prediction sample value of the second color component using the linear prediction comprises: determining the prediction sample value such that the prediction sample value is equal to x′=ax, where x′ is the prediction sample value, x is one of the reconstructed residual sample values of the predictor color component, a is equal to Cov(Y_{ref}, C_{ref})/Var(Y_{ref}), Cov( ) is a covariance function, Var( ) is a variance function, Y_{ref} is a reference signal in a motion block for the first color component, and C_{ref} is a reference signal in a motion block for the second color component.

7. The method of claim 5, wherein:
the method further comprises obtaining, from the bitstream, a value of a parameter; and
generating the prediction sample value of the second color component using the linear prediction comprises: determining the prediction sample value such that the prediction sample value is equal to x′=ax, where x′ is the prediction sample value, x is one of the reconstructed residual sample values of the predictor color component, and a is the parameter.

8. The method of claim 5, wherein generating the prediction sample value of the second color component using a linear prediction comprises: determining the prediction sample value such that the prediction sample value is equal to x′=ax+b, where x′ is the prediction sample value, x is one of the reconstructed residual sample values of the first color component, a is equal to Cov(Y_{ref}, C_{ref})/Var(Y_{ref}), and b is equal to Mean(C_{ref})−a·Mean(Y_{ref}), where Cov( ) is a covariance function, Var( ) is a variance function, Mean( ) is a mean function, Y_{ref} is a reference signal in a motion block for the first color component, and C_{ref} is a reference signal in a motion block for the second color component.

9. The method of claim 1, wherein generating the prediction sample value of the second color component comprises: determining the prediction sample value such that the prediction sample value is equal to x′=ax+b, where x′ is the prediction sample value, x is one of the reconstructed sample values of the first color component, a is equal to Cov(Yᵣₑₛ, Cᵣₑₛ)/Var(Yᵣₑₛ), and b is equal to Mean(Cᵣₑₛ)−a·Mean(Yᵣₑₛ), where Cov( ) is a covariance function, Var( ) is a variance function, Mean( ) is a mean function, Yᵣₑₛ is a reconstructed residual signal of a current block of the first color component, and Cᵣₑₛ is a residual signal of the current block for the second color component.

10. The method of claim 1, wherein decoding the bitstream further comprises obtaining, from the bitstream, a flag to indicate whether to use the reconstructed residual samples of the first color component to predict residual sample values of the second color component.

11. The method of claim 10, wherein the flag is coded at a sequence level.

12. A method of encoding video data, the method comprising:
generating a bitstream that comprises an encoded representation of the video data, wherein generating the bitstream comprises:
generating, by use of motion prediction, a residual signal for a first color component;
reconstructing the residual signal of the first color component, the reconstructed residual signal of the first color component including reconstructed residual sample values of the first color component; and
using the reconstructed residual sample values of the first color component to predict sample values of the second color component.

13. The method of claim 12, wherein the first and second color components are different ones of: a luma component, a Cb chroma component, and a Cr chroma component.

14. The method of claim 12, wherein generating the bitstream comprises:
generating, by use of motion prediction, an initial residual signal for the second color component;
determining a final residual signal for the second color component such that each sample value in the final residual signal for the second color component is equal to a difference between one of the predicted sample values of the second color component and a corresponding sample of the initial residual signal of the second color component;
generating a coefficient block by transforming the final residual signal for the second color component; and
including, in the bitstream, entropy-encoded data indicating quantized transform coefficients of the coefficient block.

15. The method of claim 12, wherein reconstructing the residual signal of the first color component comprises using dequantization and an inverse transform to reconstruct the residual signal of the first color component.

16. The method of claim 12, wherein using the reconstructed residual sample values of the first color component to predict residual sample values of the second color component comprises generating a prediction sample value of the second color component using a linear prediction from a reconstructed residual sample value of the first color component.

17. The method of claim 16, wherein generating the prediction sample value of the second color component using the linear prediction comprises: determining the prediction sample value such that the prediction sample value is equal to x′=ax, where x′ is the prediction sample value, x is one of the reconstructed residual sample values of the predictor color component, and a is equal to Cov(Y_{ref}, C_{ref})/Var(Y_{ref}), where Cov( ) is a covariance function, Var( ) is a variance function, Y_{ref} is a reference signal in a motion block for the first color component, and C_{ref} is a reference signal in a motion block for the second color component.

18. The method of claim 16, wherein:
the method further comprises including, in the bitstream, data indicating the value of a parameter; and
generating the prediction sample value of the second color component using the linear prediction comprises: determining the prediction sample value such that the prediction sample value is equal to x′=ax, where x′ is the prediction sample value, x is one of the reconstructed residual sample values of the predictor color component, and a is the parameter.

19. The method of claim 16, wherein generating the prediction sample value of the second color component using the linear prediction comprises: determining the prediction sample value such that the prediction sample value is equal to x′=ax+b, where x′ is the prediction sample value, x is one of the reconstructed residual sample values of the first color component, a is equal to Cov(Y_{ref}, C_{ref})/Var(Y_{ref}), and b is equal to Mean(C_{ref})−a·Mean(Y_{ref}), where Cov( ) is a covariance function, Var( ) is a variance function, Mean( ) is a mean function, Y_{ref} is a reference signal in a motion block for the first color component, and C_{ref} is a reference signal in a motion block for the second color component.

20. The method of claim 16, wherein generating the prediction sample value of the second color component comprises: determining the prediction sample value such that the prediction sample value is equal to x′=ax+b, where x′ is the prediction sample value, x is one of the reconstructed sample values of the first color component, a is equal to Cov(Yᵣₑₛ, Cᵣₑₛ)/Var(Yᵣₑₛ), and b is equal to Mean(Cᵣₑₛ)−a·Mean(Yᵣₑₛ), where Cov( ) is a covariance function, Var( ) is a variance function, Mean( ) is a mean function, Yᵣₑₛ is a reconstructed residual signal of a current block of the first color component, and Cᵣₑₛ is a residual signal of the current block for the second color component.

21. The method of claim 12, wherein generating the bitstream further comprises signaling, in the bitstream, a flag to indicate whether to use the reconstructed residual samples of the first color component to predict residual sample values of the second color component.

22. The method of claim 21, wherein signaling the flag comprises coding the flag at a sequence level.

23. A video coding device comprising:
a data storage medium configured to store video data; and
one or more processors configured to generate or decode a bitstream comprising an encoded representation of the video data, wherein as part of generating or decoding the bitstream, the one or more processors:
reconstruct a residual signal of a first color component, wherein the residual signal of the first color component is generated using motion prediction, the reconstructed residual signal of the first color component including reconstructed residual sample values of the first color component; and
use the reconstructed residual sample values of the first color component to predict residual sample values of a second, different color component.

24. The video coding device of claim 23, wherein the first and second color components are different ones of: a luma component, a Cb chroma component, and a Cr chroma component.

25. The video coding device of claim 23, wherein the one or more processors are configured to add the predicted sample values of the second color component to corresponding samples generated by dequantizing and applying an inverse transform to a coefficient block, wherein the bitstream includes entropy-encoded syntax elements indicating quantized transform coefficients of the coefficient block.

26. The video coding device of claim 23, wherein the one or more processors are configured to use dequantization and an inverse transform to reconstruct the residual signal of the first color component.

27. The video coding device of claim 23, wherein the one or more processors are configured to generate a prediction sample value of the second color component using a linear prediction from a reconstructed residual sample value of the first color component.

28. The video coding device of claim 27, wherein the one or more processors are configured to determine the prediction sample value such that the prediction sample value is equal to x′=ax, where x′ is the prediction sample value, x is one of the reconstructed residual sample values of the predictor color component, a is equal to Cov(Y_{ref}, C_{ref})/Var(Y_{ref}), Cov( ) is a covariance function, Var( ) is a variance function, Y_{ref} is a reference signal in a motion block for the first color component, and C_{ref} is a reference signal in a motion block for the second color component.

29. The video coding device of claim 27, wherein the one or more processors are configured to determine the prediction sample value such that the prediction sample value is equal to x′=ax, where x′ is the prediction sample value, x is one of the reconstructed residual sample values of the predictor color component, and a is a parameter, wherein the bitstream includes data indicating a value of the parameter.

30. The video coding device of claim 28, wherein the one or more processors are configured to include, in the bitstream, data indicating the value of a.

31. The video coding device of claim 27, wherein the one or more processors are configured to determine the prediction sample value such that the prediction sample value is equal to x′=ax+b, where x′ is the prediction sample value, x is one of the reconstructed residual sample values of the first color component, a is equal to Cov(Y_{ref}, C_{ref})/Var(Y_{ref}), and b is equal to Mean(C_{ref})−a·Mean(Y_{ref}), where Cov( ) is a covariance function, Var( ) is a variance function, Mean( ) is a mean function, Y_{ref} is a reference signal in a motion block for the first color component, and C_{ref} is a reference signal in a motion block for the second color component.

32. The video coding device of claim 27, wherein the one or more processors are configured to determine the prediction sample value such that the prediction sample value is equal to x′=ax+b, where x′ is the prediction sample value, x is one of the reconstructed sample values of the first color component, a is equal to Cov(Yᵣₑₛ, Cᵣₑₛ)/Var(Yᵣₑₛ), b is equal to Mean(Cᵣₑₛ)−a·Mean(Yᵣₑₛ), Cov( ) is a covariance function, Var( ) is a variance function, Mean( ) is a mean function, Yᵣₑₛ is a reconstructed residual signal of a current block of the first color component, and Cᵣₑₛ is a residual signal of the current block for the second color component.

33. The video coding device of claim 23, wherein the one or more processors are configured to obtain, from the bitstream, a flag to indicate whether to use the reconstructed residual samples of the first color component to predict residual sample values of the second color component.

34. The video coding device of claim 33, wherein the flag is coded at a sequence level.

35. The video coding device of claim 23, wherein the one or more processors are configured to signal, in the bitstream, a flag to indicate whether to use the reconstructed residual samples of the first color component to predict residual sample values of the second color component.

36. A video coding device comprising:
means for reconstructing a residual signal of a first color component, wherein the residual signal of the first color component is generated using motion prediction, the reconstructed residual signal of the first color component including reconstructed residual sample values of the first color component; and
means for using the reconstructed residual sample values of the first color component to predict residual sample values of a second, different color component.

37. A non-transitory computer-readable data storage medium having instructions stored thereon that when executed cause a video coding device to:
reconstruct a residual signal of a first color component, wherein the residual signal of the first color component is generated using motion prediction, the reconstructed residual signal of the first color component including reconstructed residual sample values of the first color component; and
use the reconstructed residual sample values of the first color component to predict residual sample values of a second, different color component.
